(19) United States
(12) Patent Application Publication
(10) Pub. No.: US 2018/0064144 A1
(43) Pub. Date: Mar. 8, 2018

(54) METHOD FOR PRODUCING A FOOD PREPARATION BASED ON FRUIT AND/OR VEGETABLES

(71) Applicant: Julia MALLABY ROSSLER, ROYAUME-UNI (GB)

(72) Inventors: Julia MALLABY ROSSLER, Oxford (GB); Nicolas CROWLEY, Montreal (CA)

(21) Appl. No.: 15/555,497

(22) PCT Filed: Feb. 28, 2016
(86) PCT No.: PCT/EP2016/054183

§ 371 Date: Sep. 2, 2017

(30) Foreign Application Priority Data
Mar. 2, 2015 (FR) 1551737

(51) Int. Cl. A23L 3/015; A23B 7/00; A23L 19/00

(52) U.S. Cl. CPC A23L 3/0155; A23V 2002/00; A23L 19/01; A23B 7/00

(57) ABSTRACT

The invention relates to a method for producing a viscous food preparation from a natural fruit and/or vegetable powder. The method comprises a step (E4) of adding a quantity of water to said natural fruit and/or vegetable powder in order to produce a natural viscous fruit and/or vegetable food preparation, a step (E5) of pasteurising the natural viscous fruit and/or vegetable food preparation thus produced, and a step (E6) of packaging the pasteurised viscous food preparation in a sealed food container.

### TECHNICAL DOMAIN OF THE INVENTION

This invention relates to the domain of food and more particularly applies to a method of manufacturing a food paste based on fruit and/or vegetables.

In particular, the preparation according to the invention can be swallowed directly or it can be used as a basis for the preparation of a juice or it can be added to a food, for example such as a yoghurt.

### STATE OF PRIOR ART

It is known that fruit or vegetable juice can be stored in plastic or glass bottles or in Tetrapack® type carton packages. Such containers can be heavy and cumbersome to store and transport, both for distributors and for users, particularly for a single person like a child. Consequently, ecologically, the carbon footprint for the transport of these drinks is relatively high. Furthermore, the storage of these juices in such packaging can be significantly limited in time, particularly for fresh juice, and this can be an important disadvantage.

It is known that at least some of these disadvantages can be overcome by the constitution of fruit and vegetable juices from a syrup or a food powder.

Syrups, with or without sugar, are concentrates that ordinarily include sweeteners and natural or artificial flavours with a taste that is different from the taste of the fruit and vegetables, which creates disadvantages.

Powders can be stored in cartons or in bags. However, in both cases they can be difficult to manipulate because, firstly, they can easily spread into their immediate environment (air, table, etc.) and they may also by soluble only with difficulty, particularly on the tongue or in yoghurt type foods, which also creates disadvantages.

Furthermore, when these powders are packaged in bags, the ambient humidity in the packaging room can generate lumps of powder that generate micro-perforations around the edges of the bag because the powder sticks and prevents an airtight seal, which can cause deterioration of the powder and is therefore a disadvantage.

One solution to prevent micro-perforations consists of adding anti-caking agents to the powder, for example such as maltrodextrin, silica or artificial chemicals. However, such an addition denatures the product and the taste is then no longer the same as the test of the fresh fruit or vegetables, which is a serious disadvantage.

Finally, another disadvantage of food powders lies in the fact that since these powders are very fragile when they are pure, it is very difficult to mix different tastes because that would increase the mass, in others the powder absorbs moisture and/or becomes warm during mixing, and the mix then becomes hard and/or sticky.

Therefore the invention aims to solve at least some of these disadvantages by disclosing a simple, reliable and efficient method for fabricating a natural food preparation, particularly without adding any anti-caking agents.

### General Presentation of the Invention

To achieve this, the purpose of the invention relates to a method for producing a viscous food preparation from a natural fruit and/or vegetable powder, said method comprising:
a step to add a quantity of water to said natural fruit and/or vegetable powder to obtain a viscous natural food preparation of fruit and/or vegetables,
a step to pasteurise the viscous natural food preparation of fruit and/or vegetables thus obtained, and
a step to packaging the pasteurised viscous food preparation in a sealed food container.

The term “natural fruit and/or vegetable powder” refers to a single natural fruit and/or vegetable powders, and also to a mix of natural fruit and/or vegetable powders. The term “natural” conveys the idea that the powder is obtained from fruit and/or vegetables without any added caking agent, or artificial chemical. Such a natural fruit and/or vegetable powder can be a powder derived from organic agriculture

The term “viscous food preparation of fruit and/or vegetables” refers to a viscous and homogeneous mix of water and fruit and/or vegetable powder characterised by its viscosity. This mix forms a mass with a soft consistency resulting from a mix of one or several inert powders with a liquid containing water, preferably only water or water infused with herbs or spices.

The term “air tight food container” means that the food container protects the pasteurised viscous food preparation from air and light.

Advantageously, the method according to the invention can result in a viscous food preparation starting from a powder without the addition of any added preservative, or sterilisation, and advantageously this powder can previously have been stored. Pasteurisation then makes it possible to package the viscous food preparation in a sealed food bag. Furthermore, the viscous food preparation does not have to be frozen, or deep frozen, or refrigerated, and can be preserved for example at ambient temperature, for example between 0° and 30°. The addition of water to the powder is counter-intuitive because it is known that it is better not to add moisture to a food product when it is packaged. The food container in which the viscous food preparation is packaged may for example be a food bag, or a bottle that does not allow air to enter during use, known as an “Airless” flask, or a bag in box known through its trade name Bag-in-Box® or BIB®.

The food preparation obtained with the method according to the invention is characterised in particular by its dynamic viscosity so that it can easily be packaged, particularly in a bag.

According to one characteristic of the invention, the dynamic viscosity of the food preparation at 20° C. under atmospheric pressure is between 10⁻² and 35×10³ mP·s (milliPascal seconds or centipoises), and preferably between 10³ and 35×10³ mPa·s.

The term “under atmospheric pressure” as used in this document refers to the free air pressure, with a value between 900 and 1100 hPa, preferably of the order of 1000 hPa, in a manner known to an expert in the subject.

When the dynamic viscosity of the food preparation is high, for example between 10³ and 35×10³ mPa·s, the food preparation is in the form of a paste.

On the other hand, when the dynamic viscosity of the food preparation is low, for example between 10⁻² and 5 mPa·s, the food preparation is in the form of a viscous liquid.

Also preferably, the density of the food preparation at 20° C. is between 1 and 1.2 kg/dm³.

In one embodiment of the method according to the invention, the method includes a preliminary step to dehydrate the fresh fruit and/or vegetables so as to obtain a natural power of fruit and/or vegetables.

Advantageously, the preliminary step to dehydrate the fresh fruit and/or vegetables includes drying of said fruit and/or vegetables so as to preserve their nutritional qualities, and particularly their vitamins and nutrients.

According to one aspect of the invention, this “cold drying” step is done at a temperature of less than 50° C. so that the viscous food preparation is only very slightly degraded, particularly when it is performed from apple and/or tomato powder. Such drying is known under the term “Cold spray drying”. As a variant, this cold drying can be done by vacuum drying at between 40 and 60° C.

According to one aspect of the invention, the method includes a step to store the natural fruit and/or vegetable powder, after the dehydration step.

According to another aspect of the invention, the method may include at least one step in which at least one spice, herb or flower is added to the powder or the viscous food preparation.

The pasteurised viscous food preparation is packaged under a vacuum or under controlled conditions, in other words the pasteurised viscous food preparation is protected so that it is not contaminated. Such packaging under a vacuum or under controlled conditions can improve the preservation quality of the pasteurised viscous food preparation that can thus be preserved for up to several months at a temperature equal for example to between 0 and 30° C.

Preferably, the method also includes a step for the preparation of a fruit and/or vegetable juice starting from the pasteurised viscous food preparation, after the packaging step.

Other characteristics and advantages of the invention will become clear while reading the following description with reference to the appended figures given as non-limitative examples, in which identical references are used for similar objects.

### DESCRIPTION OF THE FIGURES

FIG. 1 illustrates a procedure for applying the method according to the invention.

### DETAILED DESCRIPTION OF THE INVENTION

The method according to the invention can be used to fabricate a viscous food preparation that in particular can be diluted in water or in any other liquid suitable for the creation of a juice, that can be swallowed directly or used to acidulate a preparation for example such as a yoghurt.

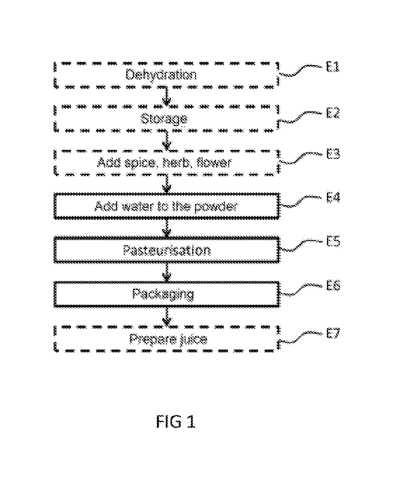

One preferred embodiment of the method according to the invention is described below with reference to FIG. 1.

In step E1, fresh fruit and/or vegetables are dehydrated to obtain a fruit and/or vegetable powder that is stable in time, in other words it does not degrade much with age and can thus be preserved, for example for several months.

In the embodiment illustrated, this dehydration includes particularly cold drying of the powder, known to an expert in the subject, to preserve vitamins and nutrients of the fruit and/or vegetables and to improve dilution of the powder in a liquid. This drying may for example be done by cold spray drying or by vacuum drying, in a manner known to an expert in the subject. Such cold drying can obtain a stable powder that dilutes well.

This powder can advantageously be stored in a step E2, for example in hermetically sealed food containers, in order to be transported and/or used later. In particular, such storage makes it possible to create food preparations using fruit and/or vegetables regardless of the season.

No binder and artificial chemical is added, such that the powder obtained is natural. This natural powder can advantageously include spices, herbs or flowers, added in a step E3, such as, for example, ginger, cinnamon, celery salt, hibiscus, elderflower or rosemary.

In a step E4, a quantity of water is added to a predetermined quantity of natural fruit and/or vegetable powder to obtain a viscous natural food preparation of fruit and/or vegetables.

For example, this viscous food preparation may include a mix composed of between 40 and 70% by weight, of fruit powder and makeup water, or a mix composed of between 30 and 70% by weight, of vegetable power and makeup water.

The viscous food preparation of fruit and/or vegetables thus obtained is in the form of a viscous and homogeneous mix of powder and water, characterised by a dynamic viscosity at 20° C., at atmospheric pressure equal to between 10⁻² and 35×10³ mPa·s. The viscous food preparation can thus equally well be in the form of a viscous paste or a viscous liquid.

In a step E5, the viscous food preparation thus obtained is pasteurised using a pasteurisation device known to an expert in the subject by heating it to a minimum temperature so that a maximum of nutrients and vitamins can be preserved. This minimum temperature depends particularly on the type of fruit and vegetables and their acidity level, and varies between 65° C. and 95° C.

When the temperature is reached, the machines starts cooling the viscous food preparation so that it does not continue to cook.

It will be noted that spices can also be added to the powder (step E3), and to the viscous food preparation before pasteurisation (step E5).

In a step E6, the pasteurised viscous food preparation is packaged in a sealed container, for example a bag, bottle or bag-in-box (BIB®) type container, or using a packaging device known to an expert in the subject.

The pasteurised viscous food preparation is packaged under a vacuum or under controlled conditions, in other words the pasteurised viscous food preparation is protected so that it is not contaminated. Such packaging under a vacuum or under controlled conditions can improve the preservation quality of the pasteurised viscous food preparation that can thus be preserved for up to several months at a temperature equal for example to between 0 and 30° C.

Preferably, although this does not limit the scope of this invention, the viscous food preparation is transferred directly from the pasteurisation device to the packaging device through a feed tube.

In one preferred usage example, in a step E7, a fruit and/or vegetable juice is prepared by diluting the pasteurised viscous food preparation packaged in the food container, in water or in any other adapted liquid. This use is in no way limitative of the scope of this invention and any other adapted use is possible, for example such as swallowing the pasteurised viscous food preparation directly or using it to acidulate a food, for example such as a yoghurt or a dessert, etc.

### Examples of Results

As an example, a mix of 20 g of pasteurised paste composed of 23% of dehydrated apple pulp, 17% of dehydrated blackcurrant juice and makeup water has the following nutritional values:

TABLE 1

| | |
|---|---|
| Energy | 192 kJ/46 kcal |
| Fat | 0.2 g |
| including saturated fatty acids | 0.0 g |
| Carbohydrate | 8.3 g |
| including sugar | 7.2 g |
| Fibre | 3 g |
| Protein | 0.4 g |
| Salt | 0.00 g |
| Vitamin C | 58 mg |

Similarly, also as an example, a mix of 20 g of pasteurised paste composed of 22.2% of dehydrated tomato pulp, 11.1% of dehydrated beetroot juice and makeup water has the following nutritional values:

TABLE 2

| | |
|---|---|
| Energy | 111 kJ/27 kcal |
| Fat | 0.3 g |
| including saturated fatty acids | 0.1 g |
| Carbohydrate | 4.1 g |
| including sugar | 3.3 g |
| Protein | 1.2 g |
| Salt | 0.06 g |
| Vitamin A | 133 μg |
| Folic acid | 35.9 μg |
| Vitamin C | 15 mg |

Therefore the method according to the invention can advantageously be used to obtain a natural food preparation, having in particular kept a large proportion of fibre, nutrients and vitamins of the original fruit and/or vegetables, without any added preservative or artificial chemical. The taste thus obtained is natural and is thus evocative of the taste of the mix of identical fresh fruit and/or vegetables.

Advantageously, the powder acting as a basis for the fabrication of the food preparation can thus be easily stored during a time period so as to be able to work in particular in tight flow and thus make mixes of powder and water at the last minute before packaging.

Therefore the dehydration following by partial rehydration steps in preparation of the food can advantageously avoid lumping problems during packaging. Furthermore, when it is packaged in a food container so that it does not come into contact with air, even after opening (for example with a membrane pump type container called an “airless pump” or of the BIB® type), it is not necessary to keep the viscous food preparation at a low preservation temperature, for example less than 6° C. in a refrigerator, and it can advantageously be preserved at an ambient temperature of between 10 and 40° C.

Finally, packaging of the viscous food preparation in a bag makes it easy for a shop to market ready-to-go product, for example in the street or on a meal tray, and makes for easy transport by an adult or by a child, for example in a pocket or in a bag.

Finally, note that this invention is not limited to the examples described above and many variants are likely that can be implemented by those skilled in the art.

1. A method for producing a viscous food preparation from a natural fruit and/or vegetable powder, said method comprising:
a step of adding a quantity of water to said natural fruit and/or vegetable powder to obtain a viscous natural food preparation of fruit and/or vegetables,
a step of pasteurising the viscous natural food preparation of fruit and/or vegetables thus obtained, and
a step of packaging the pasteurised viscous food preparation in a sealed food container.

2. The method according to claim 1, wherein the dynamic viscosity of the food preparation at 20° C. under atmospheric pressure is between 10⁻² and 35×10³ mPa·s.

3. The method according to claim 2, wherein the dynamic viscosity of the food preparation at 20° C. under atmospheric pressure is between 10³ and 35×10³ mPa·s.

4. The method according to claim 1, wherein the density of the food preparation at 20° C. is between 1 and 1.2 kg/dm³.

5. The method according to claim 1, including a preliminary step of dehydrating the fresh fruit and/or vegetables so as to obtain a natural power of fruit and/or vegetables.

6. The method according to claim 5, wherein the preliminary step of dehydrating the fresh fruit and/or vegetables comprises drying of said fruit and/or vegetables in order to preserve their nutritional qualities, and particularly their vitamins and nutrients.

7. The method according to claim 6, wherein drying is done at a temperature of less than 50° C. or between 40 and 60° C.

8. The method according to claim 1, comprising, after the dehydration step, a step of storing the natural fruit and/or vegetable powder.

9. The method according to claim 1, including at least one step in which at least one spice, herb or flower is added to the powder or the viscous food preparation.

10. The method according to claim 1, including also, after the packaging step, a step of preparing a fruit and/or vegetable juice starting from the pasteurised viscous food preparation.
